(19) United States
(12) Patent Application Publication
(10) Pub. No.: US 2016/0063099 A1
(43) Pub. Date: Mar. 3, 2016

(54) Range Map and Searching for Document Classification

(71) Applicant: Lexmark International Technology, SA, Lexington, KY (US)

(72) Inventor: Kunal Das, Kolkata (IN)

(21) Appl. No.: 14/517,234

(22) Filed: Oct. 17, 2014

(30) Foreign Application Priority Data
Aug. 29, 2014 (IN) 4233/CHE/2014

(51) Int. Cl. G06F 17/30

(52) U.S. Cl. CPC G06F 17/30707; G06F 17/3071

(57) ABSTRACT

Document classification includes a range map and corresponding search tree. The map defines a collection of one or more ranges of possible values. The search tree divides the map into searchable entities. The ranges correspond to image characteristics found in one or more documents. An unknown document fits or not within one of the ranges of values and becomes classified. Embodiments typify range types, addition or removal of ranges, applications of algorithms, searching within a tree, and imaging device execution, to name a few.

### FIELD OF THE EMBODIMENTS

The present disclosure relates to classifying or not unknown documents. It relates further to document classification via maps having ranges of values and corresponding search trees. Types of ranges, adding and removing ranges from maps, and trees and their application typify the embodiments. Execution on an imaging device is still a further embodiment.

### BACKGROUND

In traditional classification environments, a document becomes classified or not by comparison to one or more known or trained reference documents. Categories define the reference documents in a variety of schemes and documents get compared according content, attributes, or the like, e.g., author, subject matter, genre, document type, size, layout, etc. However, the more similar one reference document appears to another, different reference document, the more difficult it is to classify an unknown document by comparison. It is even more difficult during automated classification routines performed by computing devices acting solely upon documents having been digitized into discrete pixels. Complications arise further when documents have similarity one respect, but not another, e.g., two documents share a similar size and layout but have diverse content (one page, 1 kb, vendor invoice vs. one page, 1 kb, advertisement). That many examples of documents share similar attributes, but not others, it is problematic to train, store and classify random documents as belonging to one class or another.

A need in the art exists for better classification schemes for documents. The inventor recognizes that improvements should contemplate instructions or software executable on controller(s) for hardware, such as imaging devices able to digitize hard copy documents. Additional benefits and alternatives are also sought when devising solutions.

### SUMMARY

The above-mentioned and other problems are solved by range maps and search trees for document classification. Apparatus and methods provide an efficient way to store, add, and remove sets of ranges for any category type of document and to search categories associated with particular values.

In one embodiment, document classification includes a range map and corresponding search tree. The map defines a collection of one or more ranges of possible values. The search tree divides up the map into nodes, segments and root. The ranges correspond to image characteristics found in one or more documents. An unknown document fits or not within one of the ranges of values and becomes classified. Characteristics are any of a variety, but counts of contours are representative, as are content or attributes of a document. Ranges are any of a variety but contemplate one or more of the following: a closed range of values inclusive or exclusive of endpoints of the closed range; a closed range of values having each an inclusive and exclusive endpoint on either end; a half open range of values inclusive or exclusive of an endpoint on the opposite end of the half open range; a fully open range of values having no endpoints; or a single point. Search trees are any of a variety but contemplate Huffman trees or others. Bifurcation of the tree into segments, nodes and root assists in visualizing the search process.

In another embodiment, known documents of various types are extracted for their image characteristics. Ranges are established corresponding to the characteristics and are combined together for searching. Documents of an unknown type are classified by comparison to the ranges and classified accordingly.

Still another embodiment contemplates instructions or software executable on controller(s) for hardware, such as imaging devices. Imaging devices have integrated scanners able to digitize hard copy documents or can receive input from external devices. Controllers of the imaging devices can execute the establishment of range maps and searching thereof. Documents can be classified wholly within the imaging device from scanning to categorization.

These and other embodiments are set forth in the description below. Their advantages and features will become readily apparent to skilled artisans. The claims set forth particular limitations.

### BRIEF DESCRIPTION OF THE DRAWINGS

FIG. 1 is a diagrammatic view of a document classification environment, including flow chart according to the present disclosure;

FIGS. 2A-2G are diagrammatic views of various range types;

FIGS. 3A and 3B are diagrammatic views of an exemplary range map and pictorial representation of a range tree;

FIG. 4 is a diagrammatic view of a range map and corresponding search tree;

FIGS. 5A-5H are diagrammatic views of various range types and their corresponding search trees;

FIG. 6 is a diagrammatic view of a merger opera; and

FIGS. 7A and 7B are diagrammatic views of a range map and corresponding search tree and an added range and corresponding search tree.

### DETAILED DESCRIPTION OF THE ILLUSTRATED EMBODIMENTS

In the following detailed description, reference is made to the accompanying drawings where like numerals represent like details. The embodiments are described to enable those skilled in the art to practice the invention. It is to be understood that other embodiments may be utilized and that changes may be made. The following, therefore, is defined by the appended claims and their equivalents. In accordance with the features of the invention, methods and apparatus teach range maps and search trees for document classification.

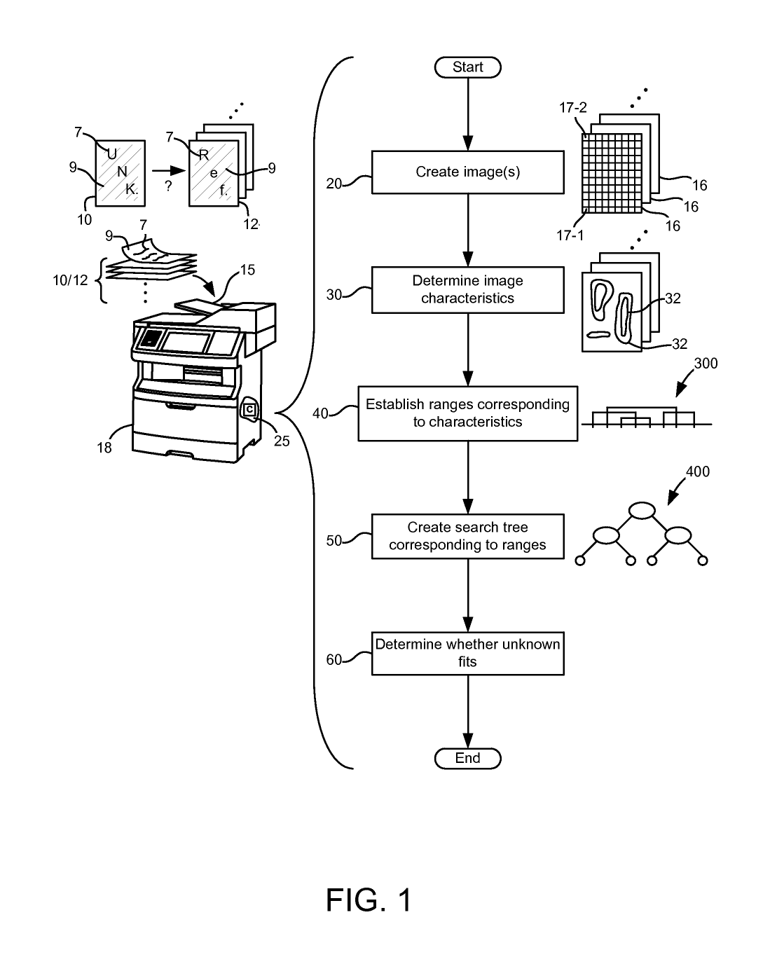

With reference to FIG. 1, an unknown document 10 is classified or not as belonging to a group of one or more reference documents 12. The documents are any variety of a type, but commonly hard copies in the form of invoices, bank statements, tax forms, receipts, business cards, written papers, books, etc. They contain either text 7 and/or background 9. The text typifies words, numbers, symbols, phrases, etc. having content relating to the topic of the document. The background represents the underlying media on which the content appears. The background can also include various colors, advertisements, corporate logos, watermarks, textures, creases, speckles, stray marks, row/column lines, and the like. Either or both the text and background can be formatted in a structured way on the document, such as that regularly occurring with a vendor's invoice, tax form, bank statement, etc., or in an unstructured way, such as might appear with a random, unique or original document.

Regardless of type, the documents 10, 12 have digital images 16 created at 20. The creation occurs in a variety of ways, such as from a scanning operation using a scanner and document input 15 on an imaging device 18. Alternatively, the image comes from a computing device (not shown), such as a laptop, desktop, tablet, smart phone, etc. In either, the image 16 typifies a grayscale, color or other multi-valued image having pluralities of pixels 17-1, 17-2, . . . . The pixels define text and background of the documents 10, 12 according to their pixel value intensities. The amounts of pixels in the images are many and depend upon the resolution of the scan, e.g., 150 dpi, 300 dpi, 1200 dpi, etc. Each pixel also has an intensity value defined according to various scales, but a range of 256 possible values is common, e.g., 0-255. The pixels may be also in binary form (black or white, 1 or 0) after conversion from other values or as a result of image creation at 20. Regardless, the images in their digital form are received at a controller 25 for further processing. The controller can reside in the imaging device 18 or elsewhere. The controller can be a microprocessor(s), ASIC(s), circuit(s) etc.

At 30, characteristics of the images are determined. This includes defining an attribute or content of interest in the document that will help separate a document of a first type from a document of a next type and quantifying that attribute or content as a value. For instance, edges or contours 32 are often noted in images for various processing techniques. If those distinguish or identify documents as one particular type, but not another, a classification may seek to count or quantify the contours as a number. That is, if a document embodied as a United States 1040 tax form, say with contours on the order of 170-190 counts (not established as fact, but given as an example), can be distinguished from a document embodied as a W-2 tax form, say with contours on the order of 250-290 contours (also not established as fact, but given as an example), then when an unknown document of either form is compared to both and has a contour count of 185, the unknown can be classified as a 1040 tax form, for example. Similarly, when an unknown document of either form is compared to both and has a contour count of 288, the unknown can be classified as a W-2 tax form, for example. Of course, other examples of image characteristics can be noted that distinguish one document from another. Without limitation, representative examples include document size, type, various forms of metadata, OCR results, content, etc.

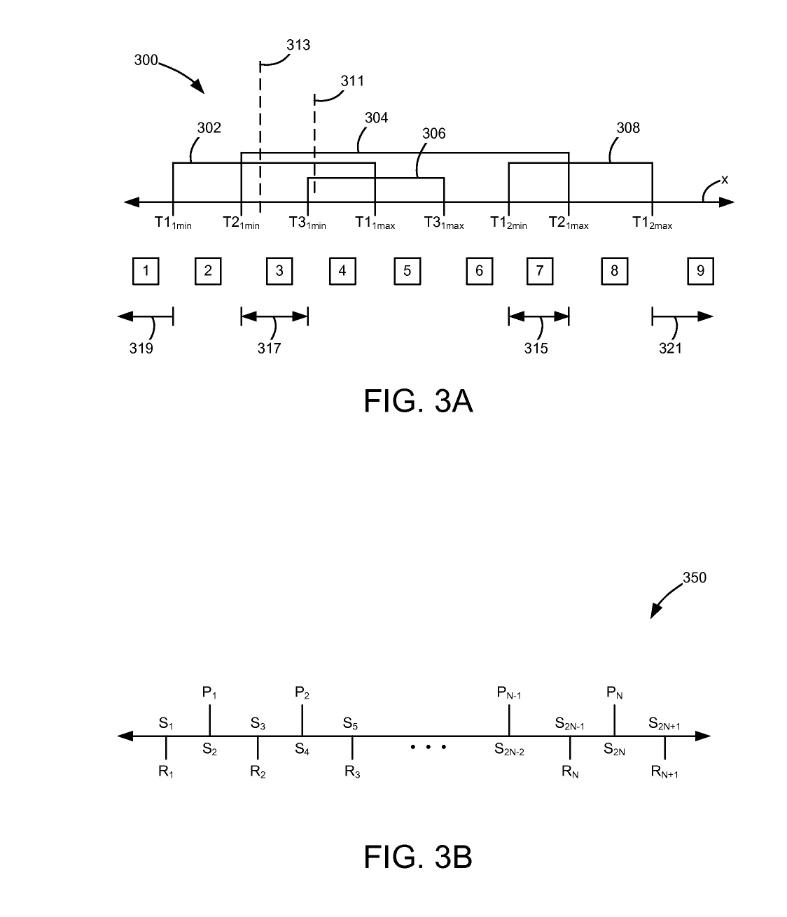

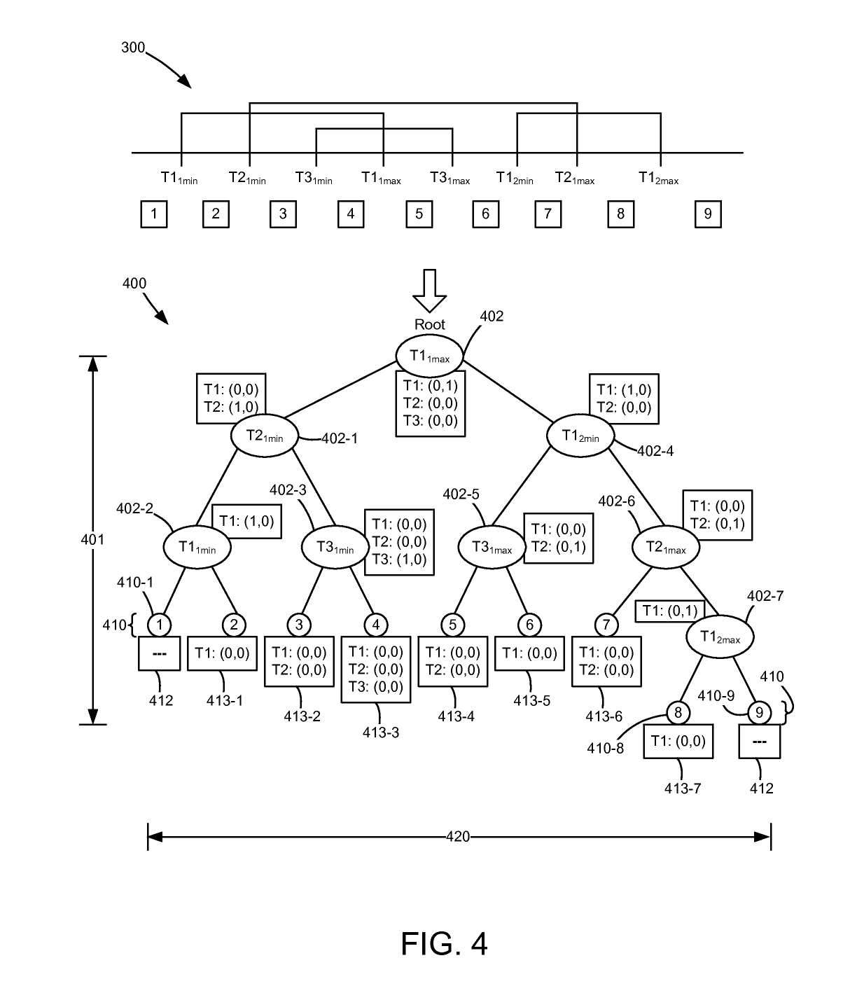

Regardless of the image characteristic selected for document classification, it may be noted in a range of numerical values that get established at 40 through training or observation of known documents. For example, a very first time that a known document of type 1040 tax form gets its contours counted, a number may be on the order of 181. A second time that a different 1040 tax form gets its contours counted, a number may be on the order of 172. Then a third time, fourth time, fifth time, etc. Eventually, a range of values gets revealed (e.g., a range of 170-190 counts) that identifies the characteristic of the image under consideration. Similarly, a document of a second type will have a second range of values, as will a document of a third type, fourth type, and so on. When graphed, the ranges of values can be seen in a map of values 300, FIG. 3A. As will be described in more below, this range map can be converted into a corresponding search tree (400, FIG. 4) at 50, FIG. 1, and searched to determine whether or not an unknown document fits within one of the ranges, 60. If the unknown fits, it can be classified according to the type of document whose range it fits. If not, the unknown remains unknown or unclassified.

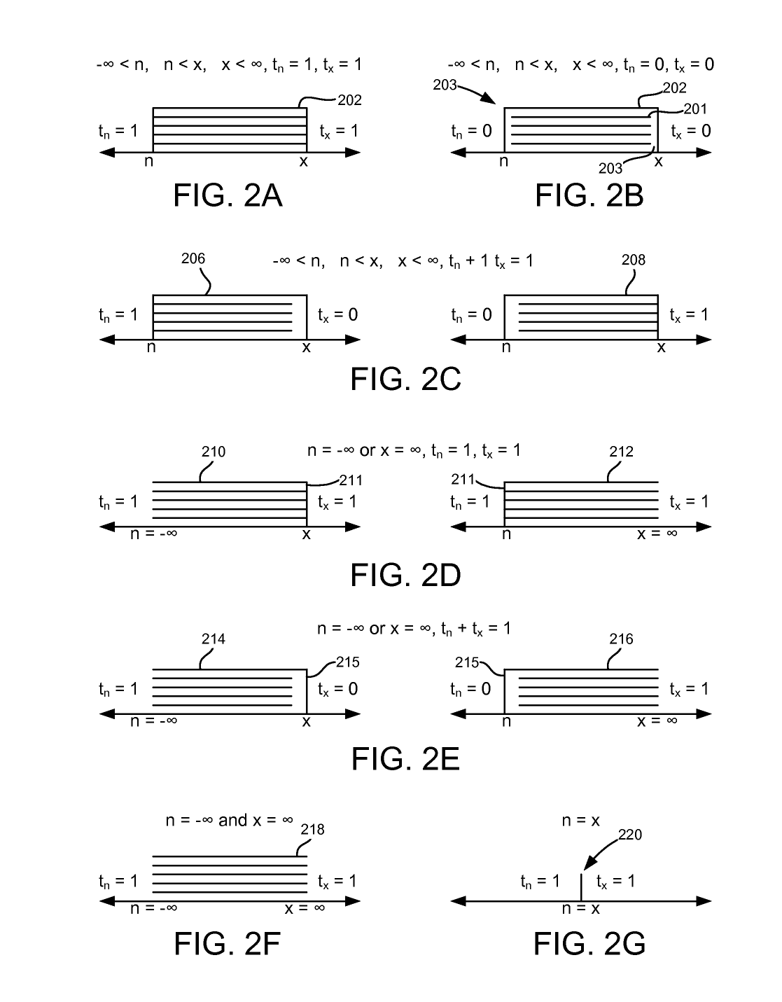

Before creation of the range map and corresponding search tree, it is first relevant to note the various types of ranges that a document of type (T) can take upon training, as shown in FIGS. 2A-2G. As a mathematical illustration, a range of values within a particular value continuum N can be defined as a tuple Z, such that

Z=(n, tₙ, x, tₓ) where

nεN is minimum value of range within the value continuum
tₓε{0, 1), tₙ=1 if n is inclusive within the range, tₙ=0 if n is exclusive

xεN is maximum value of range within the value continuum
tₓε{[0, 1), tₓ=1 if x is inclusive within the range, tₓ=0 if x is exclusive

so that −∞≦n≦x≦∞, x≠−∞, n≠∞

If n=−∞, tₙ=1 must hold. Similarly, if x=∞, tₓ=1 must hold.
If n=x, both tₙ=1 and tₓ=1 must hold.

Depending upon the values of the minimum (n), maximum (x), tₙ, and tₓ there can be seven types of ranges of values, along with their respective visual representations. In FIG. 2A, a closed range 202 includes two endpoints minimum (n), maximum (x) that are inclusive in the range, e.g., tₙ=1 and tₓ=1, and n is greater than negative infinity and less than x as x is also less than positive infinity. In FIG. 2.13, a closed range of values 204 is the same as FIG. 2A, with the exception that the two endpoints minimum (n) and maximum (x) are exclusive of the range, e.g., tₙ=0 and tₓ=0, noted pictorially where lines 201 have a space 203 and are prevented from fully reaching the minimum (n) and maximum (x) values. In FIG. 2C, a closed range of values 206 or 208 has one endpoint inclusive in the range and one endpoint exclusive of the range, e.g., tₙ=1 and tₓ=0, or tₙ=0 and tₓ=1.

In FIG. 2D, the range of values 210 or 212 is defined as a half-open range, such that only one endpoint exists and is inclusive of the range at 211, e.g., tₙ=1 or tₓ=1, while the opposite end of the range either the minimum (n) or maximum (x) extends to and equals negative infinity or positive infinity, respectively. Similarly, FIG. 2E shows a range of values 214, 216 defined as a half-open range, such that only one endpoint exists and is exclusive of the range at 215, e.g., tₙ=0 or tₓ=0, while the opposite end of the range either the minimum (n) or maximum (x) extends to and equals negative infinity or positive infinity, respectively.

Conversely, FIG. 2F shows a fully open range 218 extending from negative infinity to positive infinity. It has no endpoints. In FIG. 2G, the range 220 consists of but a single point range. The minimum (n) equals the maximum (x).

Regardless of range type, a range corresponds to a category C, where cεC, the set of all categories. In turn, a collection of ranges combines together in a map, for instance, and includes one or more of the individual types of ranges of FIGS. 2A-2G. With reference to FIG. 3, a representative map 300 includes four merged together ranges of values 302, 304, 306, 308. Each range of values corresponds to a type (T) and such type can come from any type definition, but representatively comes from FIG. 1 defining a type of document, e.g., a 1040 tax form or a W-2 tax form, according to image characteristics defined at 30 empirically grouped into ranges at 40.

Also, the types (T), with four given as (T1, T2, T3, with type T1 having two possible ranges 302 or 308), have a minimum (min) and maximum (max). In general, it can be said that:

Tᵢⱼ_{_{minα}}ε [symbol] represents minimum-side limit of i^{th} range associated with i^{th} category; and
Tᵢⱼ_{_{maxα}}εN represents maximum-side limit of j^{th} range associated with i^{th} category.

As the inventor has discovered through experiments with natural number ranges involving categories, some ranges associated with a category may actually overlap (when maxima of both the ranges are greater than minima of both the ranges), as can be found in FIG. 3A, such as at dashed line 311. Specifically, ranges of values 302, 304 and 306 for types T1₁, T2 and T3, respectively, all include a value at the x position 311 in map 300. Specific terms will now be defined for a border point, segment and node in the map.

Border Point:

A border point represents one end point of a range of values. In FIG. 3A, all T#_{#min or max} (e.g., Tᵢⱼ_{_{□}}□) are border points for the ranges of values 302, 304, 306, and 308, e.g., T1₁ₘᵢₙ, T2₁ₘᵢₙ, T3₁ₘᵢₙ, T1₁ₘₐₓ, T3₁ₘₐₓ, T1₂ₘᵢₙ, T2₁ₘₐₓ, T1₂ₘₐₓ. A border point is also associated with zero or more categories. For each category, the border point can be associated with either the minimum or maximum side, or completely within the range. For example, T2₁ₘᵢₙ is at minimum side for the type T2 category 304, and within the range of the type T1₁ category 302, and not associated with the type T3 category at all.

Segment:

A segment is a continuous section in the continuum of a range of values, within which no border points exist. Segments are labeled numbers 1 to 9 in square boxes in FIG. 3A. As an example, segment 7 ranges in continuous values at 315 between the border points T1₂ₘᵢₙ, and T2₁ₘₐₓ. Similarly, segment 3 ranges in continuous values at 317 between the border points T2₁ₘᵢₙ and T3₁ₘᵢₙ. A segment can be close-ended if it is bounded by two border points one at each end, e.g., segments 2 through segments 8. A segment is half-open-ended if it is bounded by a border point at only one end and unbounded at the other end, e.g., segments 1 and 9 at 319 and 321. A segment is open-ended if it is unbounded at both of its ends (not shown in FIG. 3A, but such as would occur with a range of values noted at the open-ended range 218 in FIG. 2F).

A segment is also associated with zero or more categories. For each category, the segment can be associated at the minimum or maximum side, or completely within the range of that category. For example, segment 3 is associated with both type T1₁ and type T2 categories at 313, but not with type T3 category, which starts from the border point just after this segment. One way to visually understand which categories are associated with the segment is to note the ranges associated with which category crosses/covers that segment.

Node:

A node is a generic term for either a border point or a segment. As a result, a node is also associated with zero or more categories.

The inventor has observed the following for N number of border points: 1) there are N+1 segments in a range map for N border points, e.g., there are nine segments (1-9) in FIG. 3A for eight border points T1₁ₘᵢₙ, T2₁ₘᵢₙ, T3₁ₘᵢₙ, T1₁ₘₐₓ, T3₁ₘₐₓ, T1₂ₘᵢₙ, T2₁ₘₐₓ, T1₂ₘₐₓ; if N>0, the first and last segments of the range map are half-open-ended segments, e.g., segments 1 and 9, while all other segments are close-ended segments, e.g., segments 2-8; and if N=0, there is only one open-ended segment in the range map, e.g., the range of values noted at 218 in FIG. 2F. If two ranges of values (not shown but defined as ranges of values 1 and 2 having border points min1, max1 and min2, max2, respectively) of the same category overlap, e.g., border points min1<min2<max2<max1, or min1<min2<max1<max2, these two ranges can be merged together to form a single composite range for that category, e.g., a single range extending between border points min1-max1 or min1-max2, respectively. This way, merging can be done with a cascading effect.

### EXAMPLE

### Description of a Data Structure

To effectively store the range map as a data structure for a computing memory, and act upon the data structure, the inventor proposes representing range maps 300 as a corresponding search tree 400, FIG. 4, having searchable entities. The tree should also be height-balanced, e.g., height 401 with relative symmetry about the root node 402. A Huffman tree is but one example of such a tree. Also, the search tree corresponds to the range map with internal nodes representing border points and leaf nodes representing segments. Specifically, the search tree 400 corresponds to the range map 300 with: internal nodes 402-1-402-7 representing border points, e.g., T1₁ₘᵢₙ, T2₁ₘᵢₙ, T3₁ₘᵢₙ, T3₁ₘₐₓ, T1₂ₘᵢₙ, T2₁ₘₐₓ, T1₂ₘₐₓ; and leaf nodes 410 representing segments of the range map, e.g., segments 1-9, whereby the leftmost 410-1 and rightmost 410-9 leaf nodes (corresponding to the first and last segments, respectively) are not associated with any category 412, unless such a category were to exist as a half-open-ended or open-ended range (not shown).

Structure of Each Node:

Each node within the tree contains:

References to left child, right child and parent nodes, described as Left(Node), Right(Node) and Parent(Node) respectively (E.g., internal node 402-1 (T2₁ₘᵢₙ) has a left child at 402-2 (T1₁ₘᵢₙ), a right child at 402-3 (T3₁ₘᵢₙ) and a parent at 402 (T1₁ₘₐₓ)); ∀Node as Segment, Left(Node)=0 and Right(Node)=0; ∀Node as border point, Left(Node)≠0 or Right(Node)≠0; and at 402, For root node Rᵣ, Parent(Rᵣ)=0.

The value of the border point representing the location of the point in the range of values is described as Value(Node). When ∀Node as Segment, Value(Node)=INVALID all internal nodes (border points) in the binary search tree have a value that is greater than the value of all internal nodes (border points) in its left sub-tree; and less than a value of all internal nodes (border points) in its right sub-tree.

The height of the node within the tree (integer value) is described as Height(Node)

∀Node as segment, Height=0
∀Node as border point, Height=1+max(Height(Left(Node)), Height(Right(Node)))

A set of key-value pairs

M={(K, [symbol] (V [symbol] ₘᵢₙ, Vₘₐₓ)); KεC and Vₘᵢₙ, Vₘₐₓε(0, 1)} where

C is the set of all categories,

Vₘᵢₙ, Vₘₐₓ are respectively minimum and maximum border type of K for the range

### i.e. f:K→(Vₘᵢₙ, Vₘₐₓ)

M may be also referred as Map(Node).

Structure of the Range Map and Corresponding Search Tree:

Let us define the following:

Y_{N} is a range tree containing N border point nodes in it, where N≧0
Therefore Y_{N} contains (N+1) segment nodes as leaves.
T_{N}=2×N+1, where T_{N} is the total number of nodes in the value continuum sorted from lowest (1) to highest (2×N+1). Sequentially, each node is represented by Sᵢ, where 1≦i≦T_{N} i.e. Y_{N}=(Sᵢ: 1≦i≦2×N+1),

( ) denotes an ordered set,

Sᵢ is
a border point node for all even i.
a segment node for all odd i.

For a height-balance search tree where N>0, the border point node resides at the median position one-half (½) of 420 among all border point nodes and is chosen as the root node 402. If there are an odd number of border points, there is but one median node. But if there is an even number of border points, there is a pair of median nodes. For a right-tilted range tree as seen at 400, e.g., nodes 410-8, 410-9 hanging lower to the right side of 420, a left-side median node is chosen as the root node (number of border nodes in left sub-tree is more than that of right sub-tree). Conversely, for a left-tilted range tree, a right-side median node is chosen as the root node (number of border nodes in left sub-tree is more than that of right sub-tree). Thus,

if Sᵣ is the root node then
r=1 when N=0
for a right-tilted range tree,

$$r = 2 \times ⌊ \frac{N + 1}{2} ⌋ when N > 0 ;$$

and
for a left-tilted range tree,

$$r = 2 \times ⌈ \frac{N + 1}{2} ⌉ when N > 0.$$

Alternatively, a range tree Y_{N} can be represented by an alternating sequence of a segment node (represented by Rᵢ) and a point node (Represented by Pⱼ) where

1≦i≦N+1 and 1≦j≦N

i.e. Y_{N}=(R₁, P₁, R₂, . . . , P_{N}, R_{N+1}), ( ) denotes an ordered set.

Pictorially, Y_{N} can be visualized at 350 as seen in FIG. 38:

If Rⱼ=Sᵢ then i=2×j−1, and if Pₖ=Sᵢ then i=2×k.

The sequence starts with

R₁, Rᵢ is followed by Pᵢ; and Pᵢ is followed by Rᵢ₊₁ for 1≦i≦N.

### Corollary:

In the beginning when N=0, a range tree Y₀ contains only one leaf node which is associated with no category; i.e. for Y₀, M₁ is empty.

Only a border node can be a root node in Y_{N} where N>0.

In a binary search tree, where the value of all nodes in left sub-tree of a node are less than the value of the node, and value of all nodes in right sub-tree of that node are more than the value of the node, all odd nodes (range nodes) will be leaf nodes.

For a height-balanced binary search tree, time complexity of searching is O(ln N) where N is the size of the tree.

N is comparable with the number of merged ranges within the value continuum.

For each category 413, each adjacent node has associated border type which can be either a series starting with (1, 0) and ending with (0, 1), with zero or more nodes with (0, 0) border types in between; or directly (1, 1) border type.

When representing in a map and corresponding search tree any of the single ranges of values of FIGS. 2A-2G, reference is taken to Figures SA-5G, respectively. Initially, however, it was noted that any range could be described as Z=(n, tₓ, x, tₓ). In a range map, every range is associated with a category

cεC where C is the set of all categories.

As such, a pair (Z,c) can be represented within a range map. This pair (Z, c) will be described as a categorized range for each of the seven ranges of values.

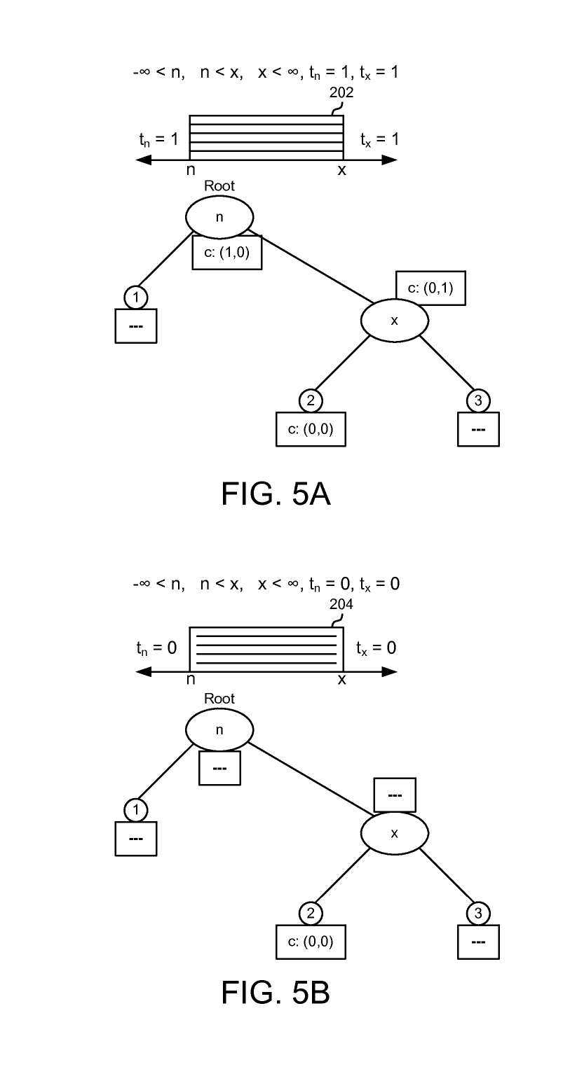

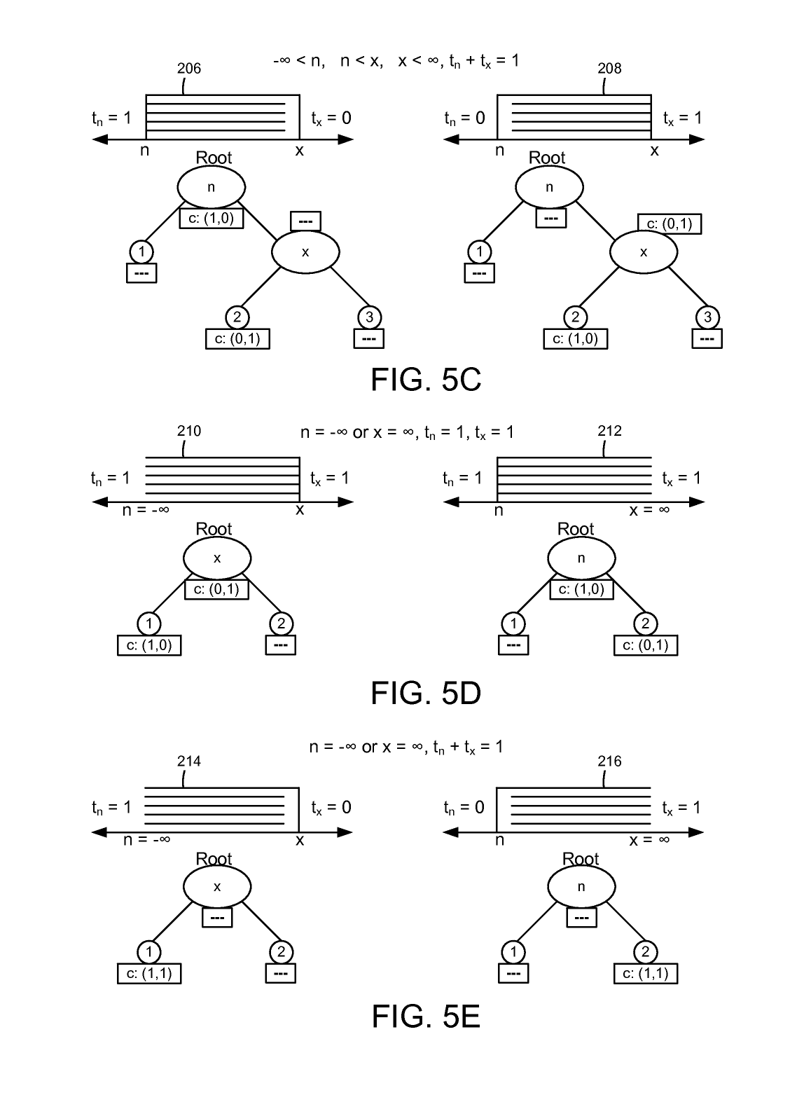

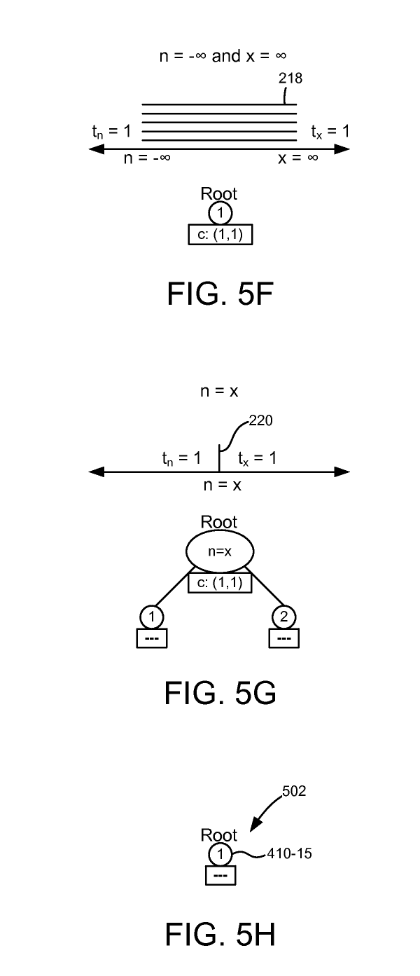

In FIG. 5F, it should be noted that there is an empty set during training time in which there is yet a document category or type. In turn, there is no range of values, no starting point. As such, when range map is Y₀ without any specified ranges, there is only one segment node 410-15 in the tree 502.

Keeping in mind, that one or more ranges might require insertion into or deletion from a map and its corresponding tree, the following provides a representative technique therefore.

### EXAMPLE

### Addition of New Range of Values into a Range Map

A categorized range (Z,c) where Z=(n, tₙ, x, tₓ) (all terms n, tₙ, x, tₓ already defined earlier) is to be added into the tree Y_{N} already containing N border nodes. In general, a range map can be perceived as a combination of categorized ranges. The inventor defines:

$${Y}_{2 \times K - k} = {\sum }_{i = 1}^{K} ( {Z}_{i} , {c}_{i} ) ,$$

where K is the number of categorized ranges in the range map, and k is the number of removed border point nodes as a result of overlapping, or repetition of same points in multiple ranges, Thus, the inventor uses addition as a binary operator in merging operation of (A) one categorized range, or (B) one second range map, into a range map in the following way:

(A)

Y_{L}=Y_{N}+(Z, c)

Here L=N+p−k, where p is the number of border point nodes in (Z, c), 0≦p≦2
k is the number of removed border point nodes.

Redundant border points appear as a result of overlapping and because of same points appearing in both range maps.

(B)

Y_{L}=Y_{N}+Y_{K}

Here L=N+K−k, where k is the number of removed border point nodes.

Since (Z, c) is a special case of Y_{K}, generic algorithm for Y_{L}=Y_{N}+Y_{K} should suffice.

Let Y_{N}=(R₁^{N}, P₁^{N}, R₂^{N}, . . . P_{N}^{N}, R_{N+1}^{N}) or Y_{N}(S₁^{N}, S₂^{N}, . . . , S_{2N+1}^{N})

and Y_{K}=(R₁^{K}, P₁^{K}, R₂^{K}, . . . P_{K}^{K}, R_{K+1}^{K}) or Y_{K}=(S₁^{K}, S₂^{K}, . . . , S_{2K+1}^{K})

Let us also denote Val(P₀^{N}), [symbol] Val(P [symbol] ₀^{K})=−∞ and [symbol] Val(P [symbol] _{N+1}^{N}), [symbol] Val(P [symbol] _{N+1}^{K})=∞(which actually do not exist on the range maps).

P₀^{N}≡S₀^{N} and P_{N+1}^{N} ≡S_{2(N+1)}^{N}

In general, Pᵢ^{N} ≡S₂ᵢ^{N} and Rᵢ^{N}≡S₂ᵢ₋₁^{N},
When two range maps are combined, the addition is segregated into two phases: Phase 1: Intersection; and Phase 2: Optimization (Elimination of redundant nodes)

Phase 1: Intersection

Let Y_{L} be the output range map. Y_{L}(S₁^{L}, S₂^{L}, . . . , S_{2L+1}^{L}) or Y_{L}=(R₁^{L}, P₁^{L}, R₂^{L}, . . . , P_{L}^{L}, R_{L+1}^{L})

Sᵢ^{L}←S_{g}_{ᵢ}^{N} ∩Sₕ_{ᵢ}^{K} ∀i, 1≦i≦2×L+1 for a unique (gᵢ, hᵢ) pair where ∩ is the intersection operator between individual nodes of two input range maps.

1≦gᵢ≦2×N+1 and 1≦hᵢ≦2×K+1

Also, 1≦i<2×L

The rule for input node pair (g, h) in forming a combination is:

$$\begin{matrix}{g}_{1} = & 1 , {h}_{1} = 1 \\ {g}_{i + 1} = & {g}_{i} + min ( 1 - ( i mod 2 ) , 1 - ( {g}_{i} mod 2 ) ) + min ( i mod 2 , 1 , ⌊ \frac{Val ( {S}_{{h}_{i} + 1}^{N} )}{Val ( {S}_{{g}_{i} + 1}^{N} )} ⌋ ) \\ {h}_{i + 1} = & {h}_{i} + min ( 1 - ( i mod 2 ) , 1 - ( {h}_{i} mod 2 ) ) + min ( i mod 2 , 1 , ⌊ \frac{Val ( {S}_{{g}_{i} + 1}^{N} )}{Val ( {S}_{{h}_{i} + 1}^{N} )} ⌋ )\end{matrix} We consider \frac{INVALID}{INVALID} = \frac{INVALID}{υ} = \frac{υ}{INVALID} = o , where υ ∈ N$$

We finally get
g_{2×L+1}=2×N+1, h_{2×L+1}=2×K+1.

Explanation of Algorithm for Intersection:

When the current output index i is odd (combination output is a segment node, so next one should be a point node), increment the index of only that input range map for which next point is further (location in value continuum towards more right side), or increment indices of both input ranges if next point is located in same place in the value continuum. When the current output index i is even (combination output is a point node, so next one should be a segment node), increment index of an input range map only if current index is even.

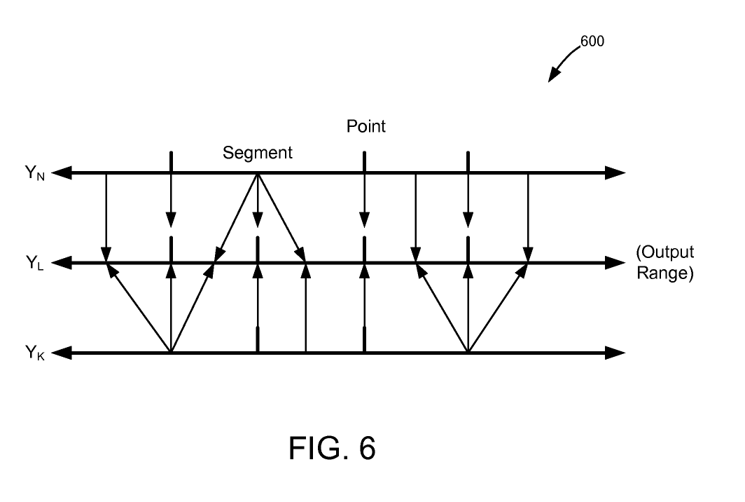

This merger operation can be pictorially represented at 600 in FIG. 6.

R←R ∩R i.e. two segments combine into one segment. The output segment is the intersection between the two input segments.

P←R ∩P i.e. a point meets a segment at a point. The input point lies within the segment, and the output point has the same value as input point.

P←P ∩R same as above.

P←P ∩P i.e. two input points have the same value in the value continuum as the output point.

Observations:

A unique (S_{g}, Sₕ) combination is used at most only once

Sequence of usage of input nodes from a range map is non-decreasing

Every S_{g} or Sₕ is used at least once in a combination in the output range map.

An input point node is used in output combination only once. A segment node is used more than once unless it is bounded by point node or nodes that are of same value in both the input range maps.

Border-type maps in output combination:

Now it is determined what will be the value of border type pair for a particular category c in each node of output range map.

Let us denote border type for category c in i^{th} node of a range map with L border nodes as Mᵢ^{L,c}, 1≦i≦2×L+1

When such a border type exists, let us define Mᵢ^{L,c}=(nᵢ, xᵢ) where n is minimum side border type and x is maximum side border type, as defined earlier.

If category c is not associated with i^{th} node of the range map, Mᵢ^{L,c}=0

when i is odd; or when i is even and gᵢ+hᵢ is even, the output is a segment node (i.e. both input nodes are also segment nodes); or output and both input nodes are point nodes.

When M_{g}_{ᵢ}^{N,c}≠0 and Mₕ_{ᵢ}^{K,c}≠0, Mᵢ^{L,c}=(min(n_{g}, nₕ), min(x_{g}, xₕ))

When M_{g}_{ᵢ}^{N,c}≠0 and Mₕ_{ᵢ}^{K,c}=0, Mᵢ^{L,c}=(n_{g}, x_{g}) [same is applicable when g and h are reversed]

When M_{g}_{ᵢ}^{N,c}=0 and Mₕ_{ᵢ}^{K,c}=0, Mᵢ^{L,c}=0,

when i is even and gᵢ+hᵢ is odd, the output is point node, and one input is point node and one input is segment node.

Without any loss of generality, let us assume gᵢ is odd (segment node)

When M_{g}_{ᵢ}^{N,c}≠0, Mᵢ^{L,c}=(0, 0)

When M_{g}_{ᵢ}^{N,c}=0, Mᵢ^{L,c}=(nₕ, xₕ)

Phase 2: Optimization

Condition 1: Mᵢ₋₁^{L,c}=(nᵢ₋₁, 0) and Mᵢ₊₁^{L,c}=(0, xᵢ₊₁)
Condition 2: Mᵢ₋₁^{L,c}=(nᵢ₋₁, 1) and Mᵢ₊₁^{L,c}=(1, xᵢ₊₁) and Mᵢ^{L,c}≠0

### Condition 3: Mᵢ₋₁^{L,c}=0 and Mᵢ₊₁^{L,c}=0 and Mᵢ^{L,c}=0

∀i when 1<i≦2×L and i is even,
At a single node, ∀cεC where C is the set of all categories, if any one of the above three conditions satisfy,

When Mᵢ₋₁^{L,c}≠0, Mᵢ₋₁^{L,c}=(nᵢ₋₁, xᵢ₊₁)

Make Sᵢ^{L}, Sᵢ₊₁^{L} [symbol] Y_{L} (i.e. remove these two nodes from range map)

∀i, 1<i≦2×L, ∀cεC where C is the set of all categories, when xᵢ=nᵢ₊₁=1, xᵢ=0, nᵢ₊₁=0

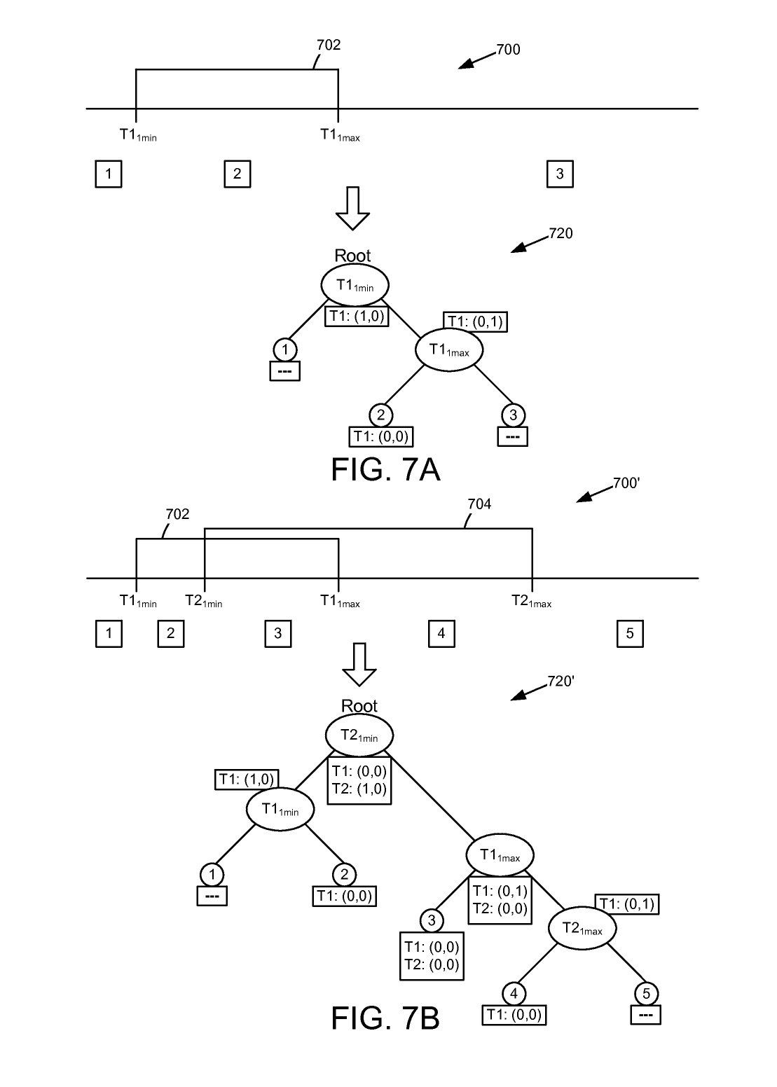

With reference to FIGS. 7A-7B, the following shows an example map 700, 700′ of adding a range of values 704 to an existing range of values 702 and the corresponding search trees 720, 720′ resulting there from.

### EXAMPLE

### Deletion of a Range of Values from a Range Map

Removal of a range map from another range map can be defined as,

Y_{L}=Y_{N}−Y_{K}

This is same as finding a range map Y_{L} so that Y_{L}+Y_{K}=Y_{N}
Let Y_{N}=(R₁^{N}, P₁^{N}, R₂^{N}, . . . P_{N}^{N}, R_{N+1}^{N}) or Y_{N}=(S₁^{N}, S₂^{N}, . . . , S_{2N+1}^{N})
and Y_{K}=(R₁^{K}, P₁^{K}, R₂^{K}, . . . P_{K}^{K}, R_{K+1}^{K}) or Y_{K}=(S₁^{K}, S₂^{K}, . . . , S_{2K+1}^{K})

Let us also define P₀^{N}, P₀^{K}=−∞ and P_{N+1}^{N}, P_{N+1}^{K}=∞(which actually do not exist on the range maps).

### P₀^{N}≡S₀^{N} and P_{N+1}^{N} ≡S_{2(N+1)}^{N}

### Also, M₀^{N,c}=M₁^{N,c} and M_{2N+1}^{N,c}=M_{2(N+1)}^{N,c}

In general, Pᵢ^{N}≡S₂ᵢ^{N} and Rᵢ^{N}≡S₂ᵢ₋₁^{N}
Let Y_{L} be the output range map. Y_{L}=(S₁^{L}, S₂^{L}, . . . , S_{2L+1}^{L}) or Y_{L}=(R₁^{L}, P₁^{L}, R₂^{L}, . . . , P_{L}^{L}, R_{L+1}^{L})
When range maps are combined, the subtraction or removal is segregate into two phases: Phase 1: Intersection; and Phase 2: Optimization (elimination of redundant nodes).

Phase 1 is the same as intersection during the addition operation between range maps, except the combination of input border-type maps in each node of output range map. Similarly, Phase 2 is the same as optimization during addition operation between range maps. As such, only the changed-part of the algorithm is noted below.

Border-type maps in output combination:

Now it is determined what will be the value of border type pair for a particular category c in each node of output range map.

Let us denote border type for category c in i^{th} node of a range map with L border nodes as Mᵢ^{L,c}, 1≦i≦2×L+1

When such border types exists, let us define Mᵢ^{L,c}=(nᵢ, xᵢ) where n is minimum side border type and x is maximum side border type, as defined earlier.
If category c is not associated with i^{th} node of the range map, Mᵢ^{L,c}=0
Let us define gᵢ and hᵢ same as before (defined in algorithm for addition operation)

### When M_{g}_{ᵢ}^{N,c}=0, Mᵢ^{L,c}=0

### When Mₕ_{ᵢ}^{K,c}≠0, Mᵢ^{L,c}=0

### When M_{g}_{ᵢ}^{N,c}≠0 and Mₕ_{ᵢ}^{K,c}=0

When i is odd
Output is segment node (i.e. both input nodes are also segment nodes, R←R−R)
When Val(S_{g}_{ᵢ}₊₁^{N})<Val (Sₕ_{ⱼ}₊₁^{K}), xᵢ=x_{g}_{ᵢ}
When Val(S_{g}_{ᵢ}₊₁^{N})>Val(Sₕ_{ᵢ}₊₁^{K}),
When Mₕ_{ᵢ}₊₁^{K,c}=0, xᵢ=0
When Mₕ_{ᵢ}₊₁^{K,c}≠0, xᵢ=1
When Val(S_{g}_{ᵢ}₊₁^{N})=Val(Sₕ_{ᵢ}₊₁^{K})
When Mₕ_{ᵢ}₊₁^{K,c}=0, xᵢ=x_{g}_{ᵢ}
When Mₕ_{ᵢ}₊₁^{K,c}≠0, xᵢ=1
When Val(S_{g}_{ᵢ}₋₁^{N})>Val (Sₕ_{ᵢ}₋₁^{K}), nᵢ=n_{g}_{ᵢ}
When Val(S_{g}_{ᵢ}₋₁^{N})<Val(Sₕ_{ᵢ}₋₁^{K}),
When Mₕ_{ᵢ}₋₁^{K,c}=0, nᵢ=0
When Mₕ_{ᵢ}₋₁^{K,c}≠0, nᵢ=1
When Val(S_{g}_{ᵢ}₋₁^{N})=Val(Sₕ_{ᵢ}₋₁^{K}),
When Mₕ_{ᵢ}₋₁^{K,c}=0, nᵢ=n_{g}_{ᵢ}
When Mₕ_{ᵢ}₋₁^{K,c}≠0, nᵢ=1.
   When i is even,

the output is a point node (i.e. at least one input node is a point nodes)

When gᵢ, hᵢ are even (both input nodes are point nodes: P←P−P)
When x_{g}_{ᵢ}=1 or Mₕ_{ᵢ}₊₁^{K,c}≠0, xᵢ=1
When x_{g}_{ᵢ}=0 and Mₕ_{ᵢ}₊₁^{K,c}≠0, xᵢ=0
When n_{g}_{ᵢ}=1 or Mₕ_{ᵢ}₋₁^{K,c}≠0, nᵢ=1
When n_{g}_{ᵢ}=0 and Mₕ_{ᵢ}₋₁^{K,c}=0, nᵢ=0

When gᵢ is odd and hᵢ is even (PθR−P)
When Mₕ_{ᵢ}₊₁^{K,c}≠0, xᵢ=1
When Mₕ_{ᵢ}₊₁^{K,c}=0, xᵢ=0
When Mₕ_{ᵢ}₋₁^{K,c}≠0, nᵢ=1
When Mₕ_{ᵢ}₋₁^{K,c}=0, nᵢ=0

When gᵢ is even and hᵢ is odd (P←P−R)
xᵢ=x_{g}_{ᵢ}
nᵢ=n_{g}_{ᵢ}.

After the addition or insertion and removal operations, range tree Y needs to be height-balanced once again, so that properties of Y as described above holds for the new tree.

Complement of a range map:

A range map Y′_{N}=!Y_{N}=>Y′_{N} is the complement of Y_{N}

Complementation operation can be done in two phases:
1. Negation
2. Optimization

### Negation.

Mᵢ^{N,c}=0=>Mᵢ^{N′,c}=(1, 1)
Mᵢ^{N,c}≠0=>Mᵢ^{N′,c}=0
Optimization is the same as described earlier in the addition of a range.

There are also some properties of range maps and associated addition and subtraction operations to be noted.

Y_{N}≡Y_{K} if N=K and Value(Sᵢ^{N})≡ [symbol] Value(S [symbol] ᵢ^{K}) and Mᵢ^{N,c}=Mᵢ^{K,c}
∀i, 1≦i≦2×N+1 and ∀c εC (set of all categories)

### Y_{N}+Y_{K}=Y_{K}+Y_{N}

[symbol] (Y [symbol] _{N}+Y_{K})=Y_{Q} and Y_{N}+(Y_{K}+Y_{Q})
Y_{N}+Y_{K}=Y_{L} and Y_{N}+Y′_{K}=Y_{L} both are possible, where Y_{K}≠Y′K
Y_{L}−Y_{N}=Y_{K} implies Y_{N}+Y_{K}=Y_{L} but the opposite may not hold true.

The foregoing illustrates various embodiments of the invention. They are not intended to be exhaustive. Rather, they are chosen to provide the best illustration of the principles and their practical application to enable practice by one of ordinary skill in the art. All modifications and variations are contemplated within the scope, herein, as determined by the appended claims. Relatively apparent modifications include combining one or more features of various embodiments with features of other embodiments.

1. A method of document classification, comprising:
receiving at a controller a first range of values corresponding to characteristics of a first set of one or more documents;
receiving at the controller a second range of values corresponding to characteristics for a second set of one or more documents different than the first set;
combining together the first and second ranges of values; and
determining whether or not an unknown document fits within one of the combined together ranges of values and can be classified as either the first or second set of one or more documents.

2. The method of claim 1, further including creating a search tree for the first and second ranges of values.

3. The method of claim 2, further including defining a root, node and segment in the search tree to bifurcate a search process.

4. In an imaging device having a scanner and a controller for executing instructions responsive thereto, a method of document classification, comprising:
scanning with the scanner a plurality of documents to form images thereof defined by pixels;
determining characteristics of the images;
establishing a first range of values corresponding to the characteristics of the images for a first set of one or more of the documents;
establishing a second range of values corresponding to the characteristics of the images for a second set of one or more of the documents; and
with the controller, combining together the first and second ranges of values.

5. The method of claim 4, further including searching the combined together first and second ranges of values to determine if an unknown fits or not within one of the ranges of values.

6. The method of claim 4, further including creating a search tree for the combined together first and second ranges of values.

7. The method of claim 6, wherein the creating a search tree further includes creating a Huffman tree.

8. The method of claim 4, further including adding to the combined together first and second ranges of values a third range of values corresponding to the characteristics of the images for a third set of one or more of the documents.

9. The method of claim 4, further including removing either the first or second ranges of values from the combined together first and second ranges of values.

10. The method of claim 4, wherein the establishing the first range of values or the second range of values includes establishing a closed range of values inclusive of endpoints of the closed range.

11. The method of claim 4, wherein the establishing the first range of values or the second range of values includes establishing a closed range of values exclusive of endpoints of the closed range.

12. The method of claim 4, wherein the establishing the first range of values or the second range of values includes establishing a closed range of values inclusive of one endpoint of the closed range and exclusive of another endpoint of the closed range.

13. The method of claim 4, wherein the establishing the first range of values or the second range of values includes establishing a half open range of values inclusive of an endpoint of the half open range.

14. The method of claim 4, wherein the establishing the first range of values or the second range of values includes establishing a half open range of values exclusive of an endpoint of the half open range.

15. The method of claim 4, wherein the establishing the first range of values or the second range of values includes establishing a fully open range of values having no endpoints.

16. The method of claim 4, wherein the establishing the first range of values or the second range of values includes establishing a single point range of values.

17. The method of claim 4, wherein the determining characteristics of the images includes determining a count of contours.

18. A method of document classification, pluralities of documents being defined by images having pixels, comprising:
using documents of a first known type, determining image characteristics therefor and establishing a first range of values corresponding thereto;
using documents of a second known type, determining image characteristics therefor and establishing a second range of values corresponding thereto;
defining together the first and second ranges of values; and
determining whether or not an unknown document fits within one of the ranges of values and can be classified as the first or second known type.

19. The method of claim 18, further including scanning the documents of the first and second known type.

20. The method of claim 18, further including creating a search tree for the first and second ranges of values.
